(19) United States
(12) Patent Application Publication
(10) Pub. No.: US 2010/0070860 A1
(43) Pub. Date: Mar. 18, 2010

(54) ANIMATED CLOUD TAGS DERIVED FROM DEEP TAGGING

(75) Inventors: CHRISTOPHER S. ALKOV, AUSTIN, TX (US); LISA SEACAT DELUCA, SAN FRANCISCO, CA (US); TRAVIS M. GRIGSBY, AUSTIN, TX (US); RUTHIE D. LYLE, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/210,748

(22) Filed: Sep. 15, 2008

(51) Int. Cl. G06F 3/00

(52) U.S. Cl. 715/716; 715/700; 715/730

(57) ABSTRACT

A tagging engine can analyze deep tag data associated with a portion of media and process the tagging data into a deep tag cloud. Tag clouds can contain snapshot information about a particular media stream segment. Tag clouds for the entire duration or portions of the media stream can be aggregated. Aggregated tag clouds can be processed and compiled into a slideshow form. The tag clouds in the slideshow can be animated and presented to summarize media that includes the deep tags from which the tag clouds were derived.

### BACKGROUND

The present invention relates to the field of tagging and, more particularly, to animated cloud tags derived from deep tagging.

Often users rely on static summaries of media to gain information about the content and to determine if the content is of interest. For example, video sharing Web sites often include a brief summary associated with video for users to evaluate. These summaries which are provided by the media provider (e.g., end-user) can often be too vague or even misleading. To assist viewers, tag clouds are used which can give a viewer a good overview about the media. Tag clouds can be created from tags applied to the media by users and viewers. Tag clouds, however, do not convey time varying information about the media and no known attempt has previously been made to link deep tagging of video with cloud tags.

### BRIEF DESCRIPTION OF THE SEVERAL VIEWS OF THE DRAWINGS

FIG. 1 is a schematic diagram illustrating a set of interfaces presenting deep tag cloud visualizations during media playback in accordance with an embodiment of the inventive arrangements disclosed herein.

FIG. 2 is a schematic diagram illustrating a process flow for creating and presenting deep tag cloud visualizations in accordance with an embodiment of the inventive arrangements disclosed herein.

FIG. 3 is a schematic diagram illustrating a system for presenting deep tag cloud visualization during media playback in accordance with an embodiment of the inventive arrangements disclosed herein.

### DETAILED DESCRIPTION

The present invention discloses a solution for animated cloud tags derived from deep tagging. In the solution, a tagging engine can analyze deep tag data associated with a portion of media and process the tagging data into a deep tag cloud. Tag clouds can contain snapshot information about a particular media stream segment. Tag clouds for the entire duration or portions of the media stream can be aggregated. Aggregated deep tag clouds can be processed and compiled into a slideshow form. The tag clouds in the slideshow can be animated and presented to a user. The slideshow playback can be independent of media playback, such as to provide a quick summary of a media file, using a set of tag clouds based upon deep tags of the media file. In one embodiment, transitions between sequenced tag clouds can be smoothed to produce a smooth presentation of animated tag clouds. In one embodiment, the tag clouds can be time synchronized with media playback and can be presented during media playback.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

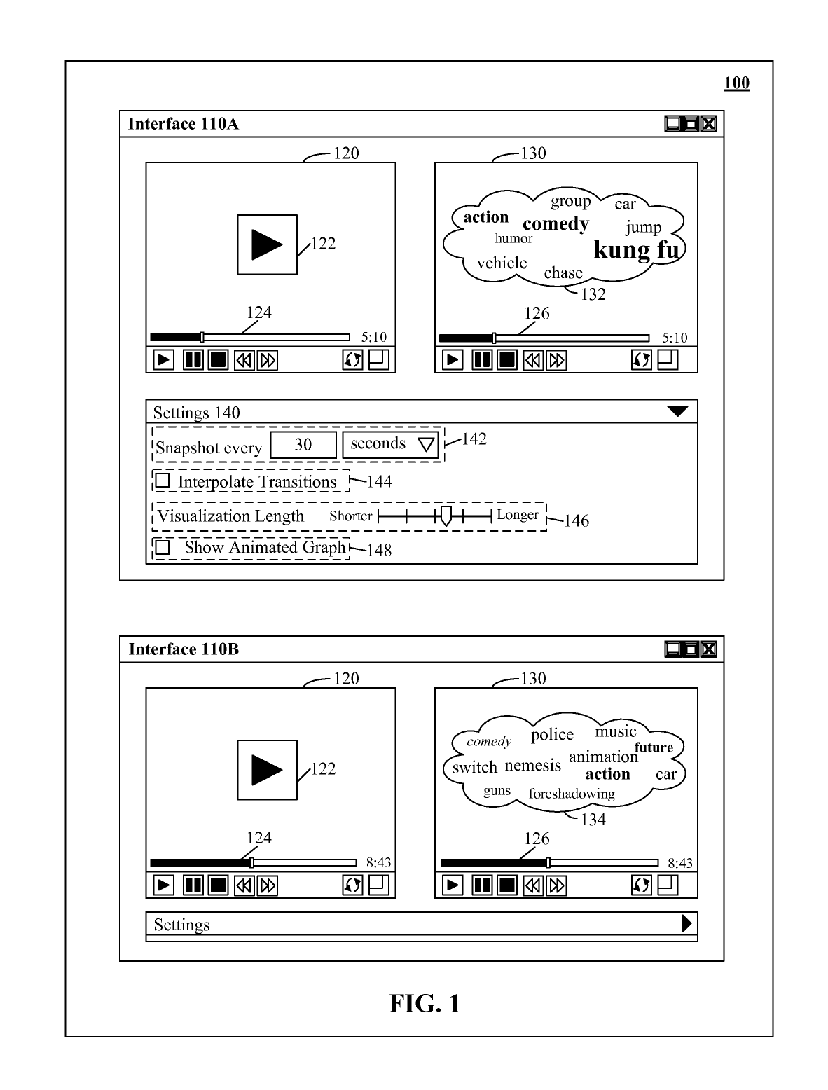

FIG. 1 is a schematic diagram illustrating a set of interfaces 110A and 110B presenting deep tag cloud visualizations during media playback in accordance with an embodiment of the inventive arrangements disclosed herein. Interfaces 110A and 110B show window 130, where a slideshow of cloud tags derived from deep tagged media are presented. The window and slide shows of cloud tags can be independent of the media from which the clouds 132, 134 are derived. For example, a set of cloud tags 132, 134 can be rapidly played in window 130 to provide a quick summary of media from which the clouds 132, 134 were derived. The slideshow playback in window 130 can, for instance, be presented within one minute for a video segment 30 minutes long.

As used herein, deep tags can be keywords associated with a portion of a media stream. Deep tag cloud visualization 132, 134 can include one or more deep tags collected and presented based on a frequency of occurrence. Deep tag clouds visualization 132, 134 can include one or more visual presentations of deep tags keywords such as presenting keywords with one or more font sizes, color, location within a region, transparency, opacity, and the like. For instance, visualizations 132, 134 can include animated deep tag clouds in which deep tags grow or shrink within a cloud graphic based on deep tag usage. In one embodiment, a deep tag cloud visualization 132, 134 can be composed into an image which can be presented with other deep tag clouds in a slideshow format.

Setting 142 can be used to configure the level of granularity for which deep tag cloud visualization 132, 134 are presented. For instance, video stream 122 can be analyzed every thirty seconds and a deep tag cloud visualization can be presented corresponding to a thirty second interval. Setting 142 can include configuration options for seconds, minutes, and hours, enabling users to configure deep tag cloud visualization 132,134 as desired. The playback pace of tag clouds 132, 134 can also be established by settings 140, which can be different from the playback pace of the associated media. For example, a tag cloud can be played back every two seconds within window 130 as part of a slideshow presentation, even though each “slide” or tag cloud represents a thirty second segment of media.

In a slideshow format, deep tag cloud visualization 132, 134 can be configured to user preferences. Settings 144 can allow deep tag cloud visualization to interpolate between slide transitions. Other settings such as overlapping slides before transitions can be configured (not shown). That is, to provide continuity to a user, it may be undesirable to abruptly remote terms from tag cloud animations. Color, transparency, shrinking to a point, or some other graphical effect may be used to indicate freshness/staleness of a particular tag. For example, when a term first appears in a tag cloud 132 it may be fully opaque. Once its use stops, it may become increasingly transparent until it reaches 100% transparency, at which point it is no longer rendered. Alternatively, a tag can be placed closer to a center of the cloud 132, 134 while it is relevant and can be moved further from the center as it becomes less relevant until it is eventually moved outside the cloud.

Setting 146 shows that a visualization may be customizable (possibly in a form of short version and long version along a sliding scale. A short version can impose a frequency threshold, such as a term only appears within a tag cloud visualization when it appears at least X number of times, the sliding scale can adjust the value of X. For example, in a short version of a visualization, it may take ten mentions of a word in a given time interval for it to appear within the visualization. In a longer version of the same visualization, only five mentions may be required for the word to appear.

Setting 148 can present animated graphs of deep tag clouds. When animation is “off” a set of static clouds 132, 134 can be presented within a slideshow. When the animation is “on” the clouds 132, 134 can smoothly transition to one another. For example, intervals of the snapshots can overlap for an improved visualization/animation effect. For example, a sliding sixty second window with snapshots taken even ten seconds can provide a relatively smooth transition from frame to frame. When transition interpolation (144) is added, a very smooth tag cloud animation can result.

Alternative representations of the visualizations are also contemplated. For example, in one embodiment, deep tag clouds can be presented in a bar graph format. For instance, a bar graph can be presented with deep tag keywords on the x-axis and the frequency on the y-axis. Other formats can include, line graph, pie chart graph, Venn diagram, and the like.

Additionally, cumulative totals can be tracked for tag usage. Visualization for cumulative totals of deep tags within a media streamed can be presented concurrently and/or independent of the tag clouds 132, 134 for distinct time segments of a media stream.

In one embodiment, (shown by interfaces 110A and 110B), the tag cloud window 130 can be time synchronized with media playback 122. The disclosure is not to be construed as limited in this regard and synchronizing media playback 122 and tag cloud playback 132 is to remain a special case of the overall disclosure. As shown, interface 110A can represent a time during media playback 122 and interface 110B can illustrate a later time during media playback 122 indicated by position bar 124. For example, at five minutes and ten seconds during video playback the interface can present animated deep tag cloud 132 and at eight minutes and forty three seconds animated deep tag cloud 134 can be presented. Position bars 124 and 126 can be synchronized which can enable a user to interact with either bar 124 or 126 to navigate within the media 122 and/or tag cloud visualization 132, 134.

Interfaces 110A, 110B can be comprised of media player 120, deep tag cloud visualization player 130, and settings 140. Media player 120 can be able to present audio/video streams, audio streams, and the like. Deep tag cloud player 130 can be configured to present deep tag clouds 132, 134 in a slideshow or video stream format. In one embodiment, interface 110A, 110B can be presented within a Web page. Alternatively, interface 110A, 110B can include a stand-alone application executing within a computing environment.

Drawings presented herein are for illustrative purposes only and should not be construed to limit the invention of any regard. Embodiments of interfaces 110A, 110B are contemplated such as graphical user interface, text user interface (TUI), multi-modal interface, and the like. As used herein, visualizations can include any combination of visual and/or aural presentation including but not limited to animation, special graphical effects, audio effects, and the like.

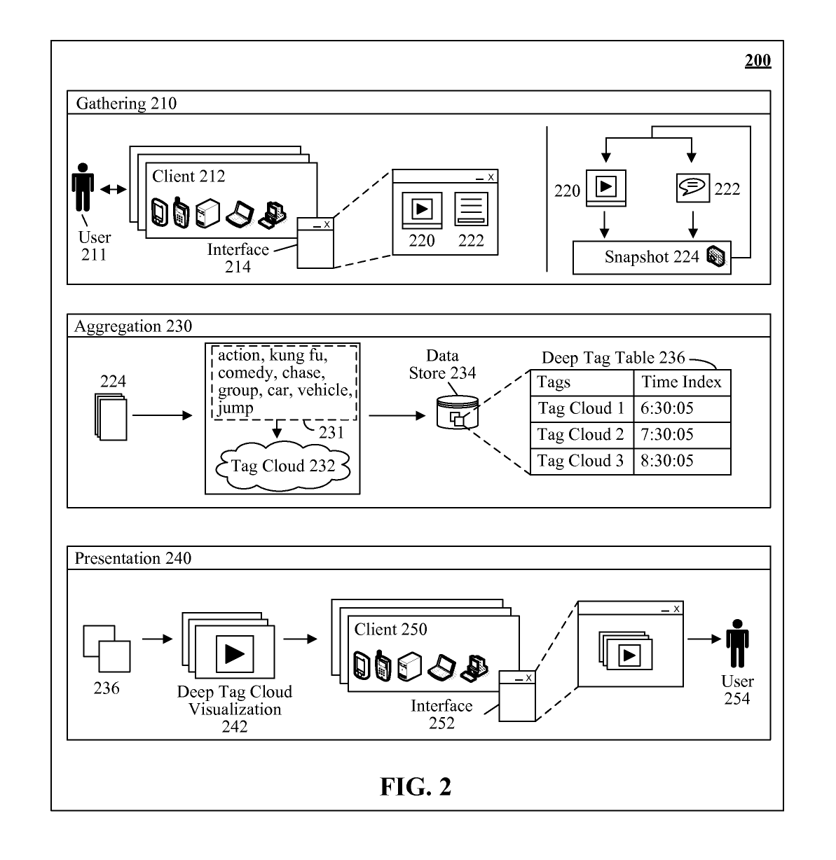

FIG. 2 is a schematic diagram illustrating a process flow 200 for creating and presenting deep tag cloud visualizations in accordance with an embodiment of the inventive arrangements disclosed herein. Phases 210-240 illustrate steps for automatically creating deep tag cloud visualizations which can be performed simultaneously and in parallel. Phases 210-240 can be facilitated by client-side and/or server-side hardware/software.

In gathering 210 phase, specific keywords (e.g., tags) can be gleaned from deep tag data (and other sources) based on keyword rules and language syntax. Further, deep tagging can result from manual efforts. In aggregation phase 230, deep tags 231 collected from deep tagging data can be associated with specific portions of the video 220. These deep tags 231 can be formed into tag groupings such as deep tag clouds 232. When performed multiple times, each portion of the media 220 can correlate a set of deep tag clouds 232. In presentation phase 240, tag clouds 232 can be included in a slideshow 242 format which can be presented to user 254. Presentation of visualization 242 can include the animation of deep tag clouds 232. This animation can be independent of the media from which the tag clouds 232 were derived. In one embodiment, tag cloud playback can be time synchronized to media 220 playback.

In gathering phase 210, deep tag data can be collected from one or more user sources. In one instance, a user 211 conversation can be analyzed by text exchange interface 214. Interface 214 can include a media stream 220 component and a text exchange 222 component. In one embodiment, during media stream 220 playback, user 211 can chat with other users about media stream 220 using text exchange 122 component. Analysis of text exchange 222 can yield deep tagging keywords useful for building a series of deep tag clouds of media stream 220. During media stream 220 playback, text exchange 222 can be filtered for tags based on word frequency. For instance, if the word “monster” is repeated in the text exchange within a sixty second time frame, the word can be included in snapshot 224. Previously deep tagged media streams can be data-mined in a similar fashion described in phase 210.

Based on the media 220 length, deep tag analysis can be performed accordingly. For example, a video that is twenty minutes in duration can be analyzed every thirty seconds, whereas a video that is one hour long can be analyzed every two minutes. Analysis can be performed for the entire duration of the media stream or for a particular time interval of interest. Alternatively, parsing can be performed in response to user 211 activity.

In aggregation phase 230, snapshot 224 containing tags 231 can be processed into a tag cloud 232. A presence of deep tags is assumed within media in aggregation phase 230 and specifics of how these tags were created is not relevant. That is, gathering phase 210 is optional and alternatives, such as manually inserting deep tags, are contemplated. In phase 230, processing can include filtering duplicate tags, determining tag frequency, and the like. Weights can be assigned to deep tags 231 which can assist in forming cloud 232 visualization. Clouds 232 can be stored in data store 234 which can be used to correlate a tag cloud with a segment of media using time indexes. For instance, table 236 data can be used to create a deep tag cloud visualization for a specific duration of a media stream or for the entire media stream. Cumulative totals can be optionally used in one embodiment.

In presentation phase 240, table 236 data can be compiled into a deep tag cloud visualization 242. Visualization 242 can be conveyed to client 250 and presented to user 254 on interface 252. For example, a user 254 can interact with a Web page artifact associated with a media stream to obtain deep tag cloud visualization 242. Navigation to points of interest based on deep tags within the media stream can be facilitated by table 236. For instance, a user 254 can interact with a deep tag within a tag cloud which can cause the media stream to skip to the point referenced by the tag. Visualization 242 can be customizable and can include options such as fade in/out transitions, expanding or abridging deep tag cloud animation, and other visualization options.

In one embodiment, the visualization 242 can be independent of the media 220 from which it was derived. That is, the visualization 242 can represent a summary presented in a tag cloud/slideshow format of the media 220.

Phases 210, 230, 240 can be repeatedly performed over the lifetime of the media stream, which can result in the deep tags, tag clouds 232, and visualizations 242 dynamically changing over time. In one embodiment, phases 210, 230, 240 can be performed in real time or near real time allowing visualization 242 to be dynamic and contemporary. That is, a real time video stream can be used as a source for creating real time tag cloud visualizations, which are based upon deep tags of the video stream.

Drawings presented herein are for illustrative purposes only and should not be construed to limit the invention in any regard. Functionality expressed in the disclosure can be embodied within middleware software, be performed by a distributed computing environment, cloud computing environment, and/or a network computing environment.

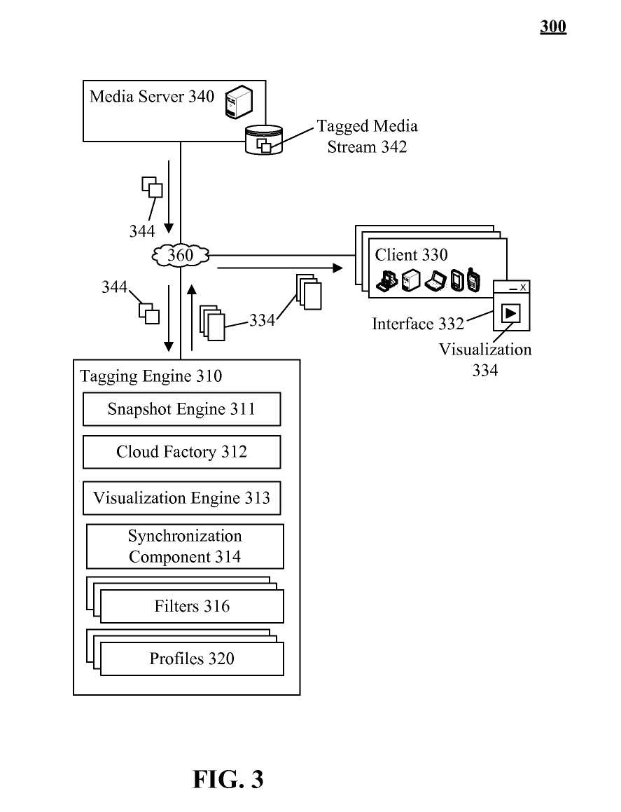

FIG. 3 is a schematic diagram illustrating a system 300 for presenting deep tag cloud visualization during media playback in accordance with an embodiment of the inventive arrangements disclosed herein. In system 300, a tagging engine 310 can facilitate the creation of a deep tag cloud visualization from automatically collected deep tags. Engine 310 can cooperate with media server 340 to enable automated deep tag aggregation. System 300 can include a networked configuration enabling engine 310, server 340, and client 330 that communicate via network 360.

Snapshot engine 311 can be used to aggregate deep tag data from tagged media stream 342. Engine 311 can process tagged media stream 342 to obtain deep tag cloud data for a portion of the media stream 342 or its entirety. For instance, client 330 can use interface 332 to specify a portion of stream 342 to acquire deep tag cloud visualizations. Snapshot engine 311 can track the cumulative totals for deep tags for each snapshot and for the entire deep tag cloud visualization. Totals can be used to generate alternate visualizations and can be used as statistics useful in summary analysis.

Cloud factory 312 can utilize deep tag data from snapshot engine 311 to create a deep tag cloud for a portion of tagged media stream 342. Factory 312 can utilize filters 316 to provide customized deep tag clouds. Factory 312 can analyze frequency occurrences of deep tags within tagged media stream 342 and assign weight values to each deep tag. Weight values can be used by visualization engine 313 to animate and present deep tag clouds.

Visualization engine 313 can utilize data from factory 312 and profiles 320 to present a user customized visualization 334. Engine 313 can present deep tag keywords within tag clouds using one or more fonts, font sizes, colors, locations, transparency, opacity, and the like. Information for animating visualization 334 can be generated by engine 313. The information can be compiled into visualization 334 which can be communicated to client 330. The interface 332 can process visualization 334 and perform visualization (e.g., animation) tasks based on information contained in visualization 334.

The optional synchronization component 314 can utilize timing information associated with media stream 342 to maintain the correlation between deep tag metadata and media stream 342 position. Timing information can be conveyed along with media stream to tagging engine 310 as data 344. Alternatively, timing information can be extracted from media 342 by engine 310. Timing information can allow component 314 to track media stream segments being processed for deep tag information. Based on data 344, component 314 can associate one or more deep tag clouds with media stream 342 segments. In one embodiment, the presentation of tag cloud visualizations can be independent of a media stream 342 from which they were derived, in which case synchronization component 314 is unnecessary.

Filters 316 can be used to control the manner in which deep tag keywords are collected. Utilized prior to tag collection, filters 316 can exclude common parts of speech, explicit language, current topics, and the like. For instance, to enable deep tags to be useful to a wide set of users, slang words can be filtered out before deep tagging data is analyzed. Alternatively, filters 316 can be applied to include unique words or colloquialisms useful to a specific group of users.

Profiles 320 can provide a means for users to adjust the behavior of deep tag cloud presentation. The profiles 320 can be configured to each users need and usage patterns. Common controls can be made available for users such as slide transitions (e.g., fade in/out), tag cloud animations, and the like. Profiles 320 can be used to store user history, such as previously accessed media, media bookmarks, and the like.

Engine 310 can be a component of a distributed computing system able to perform the functionality described herein. In one embodiment, engine 310 capabilities can be present within middleware software such as IBM WEBSPHERE. Alternatively, engine 310 can be a network element able to perform deep tag cloud creation and visualization tasks independently. Components of engine 310 can be optionally present in a client computing environment, server computing environment, or be distributed through out a computing environment as long as functionality is preserved.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for animating deep tag clouds comprising:
identifying at least one occurrence of a deep tag within a portion of a media stream corresponding to a start time index and an end time index;
creating a deep tag cloud of at least one deep tag associated with the portion of the media stream; and
presenting a visualization of at least one deep tag within the deep tag cloud.

2. The method of claim 1, wherein the presentation of the visualization is independent of a presentation of the media stream.

3. The method of claim 1, wherein the identifying of the deep tags, and the creating of the deep tag cloud are repeated to create a set of temporally ordered deep tag cloud visualizations, which are presented as a slideshow.

4. The method of claim 3, wherein the deep tag cloud visualizations are animated.

5. The method of claim 4, wherein tags within the visualizations are transitioned away when no longer present in a currently displayed deep tag cloud in a non-abrupt manner using a graphical effect that indicates at least one of freshness and staleness of presented tags.

6. The method of claim 1, further comprising:
establishing a user configurable term frequency threshold for appearance of a term within the deep tag cloud, wherein a term of a deep tag appears within the created deep tag cloud and is presented within the visualization only when a frequency of the term satisfies the term frequency threshold.

7. The method of claim 3, further comprising:
interpolating transitions from one slide to the next during slideshow playback.

8. The method of claim 3, further comprising:
overlapping intervals of the start time index and the end time index when creating consecutive tag clouds to smooth a transition from one slide to the next during slideshow playback.

9. The method of claim 1, further comprising:
tracking cumulative totals for tag usage when creating consecutive tag clouds to reflect a content summary for the overall media stream.

10. The method of claim 1, wherein the presentation of the visualization is time synchronized with media stream playback.

11. The method of claim 10, wherein the deep tag cloud is visually presented as the media stream is being visually presented.

12. A system for deep tag cloud visualizations comprising:
a deep tag cloud able to be visually presented using at least one visualization setting; and
an interface configured to present a deep tag cloud visualization.

13. The system of claim 12, further comprising:
a media player interface configured to present at least one deep tag cloud visualization as a slideshow where the deep tag clouds are derived from time segments of deep tag clouds of a media stream.

14. The system of claim 13, further comprising:
a second media player interface configured to present the media stream, wherein playback of the media stream of the second media player is time synchronized with playback of deep tag visualizations of said media player interface.

15. The system of claim 14, wherein the media stream is one of a video stream, an audio stream, and a stream comprising audio and video.

16. The system of claim 13, wherein the media player interface is configured to present user interactive deep tag cloud visualizations, wherein the user interaction results in a programmatic executable action based upon selections made within element of the deep tag cloud visualizations.

17. The system of claim 13, wherein the computation for visualization is performed by a visualization engine, wherein the visualization engine is implemented in middleware.

18. A computer program product for deep tag cloud visualizations comprising:
a computer usable medium having computer usable program code embodied therewith, the computer usable program code comprising:
computer usable program code configured to identify at least one occurrence of a deep tag within a portion of a media stream corresponding to a start time index and an end time index;
computer usable program code configured to create a deep tag cloud of at least one deep tag associated with the portion of the media stream; and
computer usable program code configured to present a visualization of at least one deep tag within the deep tag cloud.

19. The computer program product of claim 18, wherein the presentation of the visualization is independent of a presentation of the media stream.

20. The computer program product of claim 18, wherein the presentation of the visualization is time synchronized with media stream playback.
